(19) United States
(12) Patent Application Publication
(10) Pub. No.: US 2016/0139886 A1
(43) Pub. Date: May 19, 2016

(54) METHOD OF EXCHANGING DATA DESCRIPTIVE OF TECHNICAL INSTALLATIONS

(71) Applicant: AREVA NP, Courbevoie (FR)

(72) Inventors: Philippe PERDRIAU, Lyon (FR); Hondjack DEHAINSALA, Mevoisins (FR)

(21) Appl. No.: 14/896,244

(22) PCT Filed: Jun. 3, 2014
(86) PCT No.: PCT/EP2014/061505

§ 371 Date: Dec. 4, 2015

(30) Foreign Application Priority Data
Jun. 4, 2013 (FR) 13 55133

(51) Int. Cl. G06F 9/44

(52) U.S. Cl. CPC G06F 8/22

(57) ABSTRACT

A method of exchanging data descriptive of technical installations between at least two applications is provided, a said application being able to provide and/or to consume data according to an associated application data model, the method allowing interoperability between applications by virtue of an exchange of the data expressed and formalized through at least one chosen standard having an associated data model and associated exchange formats, implemented by a programmable device. For at least one application, the method includes the integration (T1x) of the application data model in a same semantic web data representation language, termed a common representation language, and, for each chosen standard, the integration (T2x) of the data model into a semantic web modeling language. The method further makes is possible to obtain (T3x) first conversion rules between the application data model in the common representation language and the data model(s) of the standards chosen in the semantic web modeling language, and to obtain (T4x) second rules of organization and control of the data to be exchanged, allowing the conversion and exchange of data of the application using these conversion rules.

The present invention relates to a method of exchanging data descriptive of technical installations between at least two applications, one said application being able to provide and/or consume data according to an associated application data model.

The invention falls within the field of the interoperability of technical data descriptive of industrial installations.

### BACKGROUND

In various industrial fields, for example in the field of energy production, the setup of an industrial site is done in a specific way and involves many industrial partners. These partners are led to exchange technical data relative to the industrial installations set up, the term “technical data” covering a functional system description implemented by the installation(s), a description of equipment, components, instrumentation, regarding their functional and operational characteristics as well as those intrinsic to the selected solution, their geometry, their assembly, their implementation and their breakdown into elementary parts (nomenclature) as well as the associated requirements, whether they relate to design, manufacturing, operation, maintenance or supply.

In order to facilitate exchanges between industrial partners, standard ISO15926 was recently developed. A description of the standard is accessible on the website: http://www.15926.org/. This standard specifies a representation of the information associated with the engineering, construction and operation of industrial installations, in particular in the field of energy production. Standard ISO15926 is made up of 9 parts, defining a conceptual data model (Part 2), a reference data set (Part 4), reference topology and geometry data (Part 3), and integration models (Part 7). The data model is based on object classes having kinship relationships, specialization relationships, the relationships between the object classes being categorized.

Other standard or proprietary formats also exist, implemented by various industrialists, for describing industrial equipment, for example standard ISO 10303 for the presentation and exchange of information relative to the manufacture of products, standard ISO 16739 for sharing data in the construction and installation management sector, standard BIM (Building Information Model), OPC Unified Architecture (OPC-UA) for the supervision of industrial installations.

The standard formats for exchanging technical data descriptive of industrial installations, for example formats ISO 10303 and ISO15926, have similar characteristics, inasmuch as they specify a descriptive language for a data model, a data model, a dictionary describing reference objects and their characteristics, and information access and exchange means.

Thus, various partners intervening at various business application levels (for example specification, equipment, civil engineering, safety validation) in the design and construction of an industrial installation can use different representations (carried by different exchange standards), representative, at least in part, of the same installations and containing shared technical data. To perform a data exchange between business applications, it is necessary either to manage files descriptive of the data, for example files in XML format, or to implement a conversion between the format used and an interoperability format such as the format defined by standard ISO15926. These two solutions are tedious and require specific development, and are complex to manage if, in the same exchange process, information relative to several disciplines (several standards) is handled coherently.

### SUMMARY OF THE INVENTION

There is therefore a need to simplify the interoperability and exchange of technical data descriptive of industrial installations.

To that end, according to a first aspect, the invention proposes a method of exchanging data descriptive of technical installations between at least two applications, a said application being able to provide and/or to consume data according to an associated application data model, the method allowing interoperability between applications by virtue of an exchange of the data expressed and formalized through at least one chosen standard having an associated data model and associated exchange formats, implemented by a programmable device.

The method according to the invention includes, for at least one considered application, the following steps:
integration of the application data model in a same semantic web data representation language, termed a common representation language,
for each chosen standard, the integration of the data model of the standard into a semantic Web modeling language,
obtaining of first rules of conversion between the application data model in the common representation language and the data model(s) of the chosen standards in the semantic Web modeling language,
obtaining of second rules of organization and control of data to be exchanged,
conversion of the application data using the first and second obtained rules into data according to the exchange format(s) associated with the chosen standards,
exchange of data obtained in the conversion step according to the exchange format(s) associated with the chosen standards.

Advantageously, the method according to the invention makes it possible to facilitate the interoperability between data models used by various applications and between various exchange formats for technical data descriptive of industrial installations.

The method according to the invention may have one or more of the features below, considered independently or in combination:
the step for obtaining first conversion rules includes the definition of the unified conversion rules between application data and the chosen standard(s), based on generic rule templates;
the first conversion rules obtained are bijective rules, allowing a conversion of the application data to the chosen standard(s), and a conversion of data according to the chosen standard(s) to data according to the application model;
the first conversion rules are expressed declaratively and stored in one or more files;
the step for obtaining first conversion rules includes the creation or update of an internal reference dictionary, in connection with the chosen standard(s);
the step for obtaining second rules includes the definition of rules of organization and control of the exchanges making it possible to meet contractual requirements, satisfy confidentiality requirements of the information to be shared, or control the information to be integrated;
said second rules define exchange lots, making it possible to filter, among the data of the application, a subset of data to be exchanged;
the integration step of the application data model in a representation language of the semantic web data, includes two sub-steps, a first sub-step for converting the application model into the semantic web data representation language and a second sub-step for actual conversion of the data of the application by instantiation of the converted application model resulting from the first sub-step;
said shared presentation language of the semantic web data is the RDF language;
said modeling language of the semantic web is the OWL language;
one of the chosen standards is standard ISO15926.

According to a second aspect, the invention relates to a programmable device for exchanging data descriptive of technical installations between at least two applications, a said application being able to provide and/or to consume data according to an associated application data model, allowing interoperability between applications by virtue of an exchange of the data expressed and formalized through at least one chosen standard having an associated data model and associated exchange formats. The device according to the invention includes, for at least one considered application, modules able to provide means for:
the integration of the application data model in a same semantic web data representation language, termed a common representation language,
for each chosen standard, the integration of the data model of the standard into a semantic Web modeling language,
obtaining of first conversion rules between the application data model in the common representation language and the data model(s) of the standards chosen in the semantic web modeling language,
obtaining second rules of organization and control of the data to be exchanged,
converting data of the application by using the first and second obtained rules into data according to the exchange format(s) associated with the chosen standards, and
the exchange of data obtained in the conversion step according to the exchange format(s) associated with the chosen standards.

The device according to the invention includes means for carrying out all of the steps of the method according to the invention briefly described above.

### BRIEF SUMMARY OF THE DRAWINGS

Other features and advantages of the invention will emerge from the description thereof provided below, for information and non-limitingly, in reference to the appended figures, in which:

FIG. 1 is a diagrammatic example of an infrastructure carrying out an embodiment of the invention;

FIG. 2 diagrammatically shows the principle of an embodiment of the invention;

FIG. 3 shows the main processing operations of the method according to an embodiment of the invention;

FIGS. 4 to 6 outline the main steps of the processing operations shown in FIG. 3.

### DETAILED DESCRIPTION

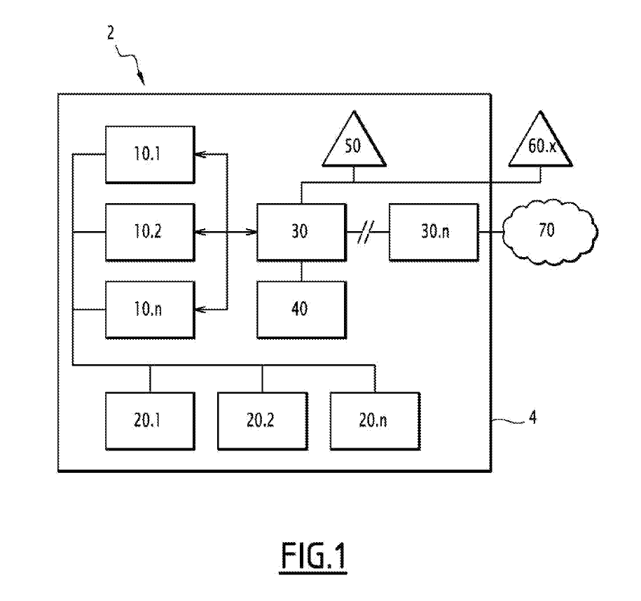

FIG. 1 illustrates an example infrastructure 2 in which the method for processing data descriptive of technical installations according to the invention is carried out.

The infrastructure 2 comprises a part 4 that is part of a company, called company infrastructure, including devices 10.1, 10.2, 10.n that are business application database servers containing the information for the different disciplines of the company that must be shared between third parties or amongst themselves. These databases in particular include data descriptive of technical installations.

The part 4 of the infrastructure 2 also comprises workstations 20.1, 20.2, 20.n containing clients of these servers 10.1, 10.2, 10.n, and a computer exchange server 30 allowing the execution of processing operations of the method according to the invention associated with a database containing the data to be published, as well as the rules of conversion and control. These conversion rules refer to dictionaries 50 managed within one of the companies, or external dictionaries 60.x maintained by third parties (standardization bodies, published by other companies or maintained by representatives of an activity sector).

The workstations 20.1, 20.2 to 20.n implement application additions connected to the computer exchange server 30 making it possible to organize exchanges, verify the data to be published or control the data to be integrated into the business databases of the servers 10.1 to 10.n.

The company infrastructure 4 also comprises one or more workstations 40 making it possible to administer the computer exchange server 30 to organize and monitor changes, establish conversion rules and verify or perform exchanges independently of the use of the workstations 20.1 to 20.n.

Optionally, a mirror server 30.m synchronous with the server 30 is present, in order to isolate the internal network of the company from a network 70 accessible from the outside, making it possible to meet the requirements of computer cyber security. The servers 30 and 30.m, according to the deployed configuration, are able to meet third-party requests and to publish files and reports according to the different formats traditionally used by exchange standards for technical data descriptive of industrial installations, for example the PDF, XLS, XML, or OWL formats.

The servers 10.1 to 10.n, 30 and the workstations 20.1 to 20.n are, in a known manner, programmable devices each including one or more processors able to perform computations and carry out computer program instructions, and information storage means able to store executable code instructions making it possible to implement programs including computer program code instructions.

Access is done through the network 70 supporting the traditional WEB technologies, whether used in a private mode (community intranet) or public mode (Internet).

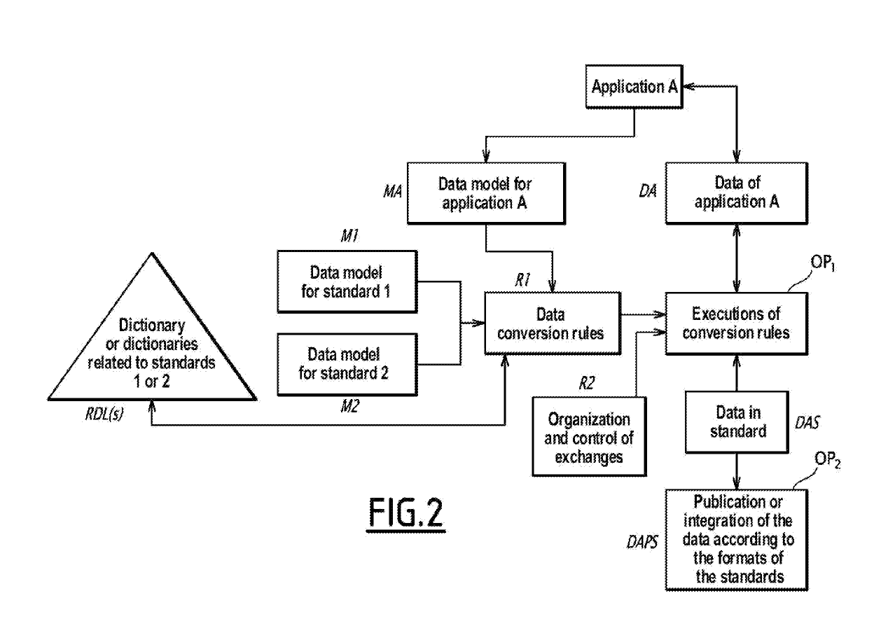

FIG. 2 diagrammatically illustrates the principle of an embodiment of the invention.

A business application A, simply called application A hereinafter, able to provide and process data representative of technical installations is described by its data model, which we call Model A (MA in FIG. 2). This application comprises information or data, denoted DA, that one wishes to publish according to different exchange standards based on its nature. In the example of FIG. 2, two standards are considered, denoted Standard 1 and Standard 2. For example, standard 1 is standard ISO15926 and standard 2 is standard ISO16739.

More generally, the invention is not limited to the use of two standards, any number of standards being able to be used while applying the principle of the invention described below.

In an alternative that is not shown, one seeks to aggregate information from another application B and to publish it in conjunction with that of the application A and still based on one or more exchange standards. In this case, model A and model B can be grouped together in a model A+B.

It is advantageous to use the semantic Web technology, in particular the RDF (Resource Description Framework) formalism, defined by the W3C (World Wide Web Consortium), for the segregation, in an incremental manner without challenging the first implementations of the coupling between the data of the application A, toward an exchange standard described in more detail below. In a known manner, the RDF formalism is a graph model designed to formally describe the Web resources and their metadata.

In the rest of the description, the processing of the data DA of application A, having a data model MA, will be outlined. However, this processing applies similarly for an application B, having an associated data model MB and data DB, and also the case of a data model A+B.

The model MA is expressed in the RDF formalism of the Semantic Web technology.

The data models of the standards, respectively denoted M1 for the data model of Standard 1 and M2 for the data model of Standard 2, are provided by the standardization bodies in a description language either directly available in the formalism of the Semantic Web, i.e., in OWL (Web Ontology Language) formalized in RDF, as is the case in the context of ISO15926, or in another language (for example, EXPRESS in the context of ISO10303).

In this second case, according to the invention, it is recommended to translate the expression of the data model of the standard (optionally with restrictions) into the OWL language of the Semantic Web in order to have a homogenous representation and to use the reasoning power of the Semantic Web. Subsequently, the data models M1, M2, etc. are considered to be expressed in the OWL language of the Semantic Web, formalized in RDF.

A first set of conversion rules (R1) is done to allow the conversion of data from the application A (also expressed in the RDF formalism and described through the data model MA) to the data model of standard M1 or M2; this work results from an analysis of MA and of M1 or M2, in relation with RDL (Reference Data Library) stored dictionaries related to Standard 1 and Standard 2.

A second set of rules for organization and control (R2) is done to organize and control the exchanges, define exchange lots and integrity controls, place version numbers or outline the exchanged or modified values.

These rules R1 and R2 are implemented on the server 30, the conversion rules R1 are obtained by programming and the organization and control rules R2 by means of a man-machine interface installed on the workstation 40.

A first processing operation OP1 is done on the server 30, taking into account the data DA (expressed in RDL), the conversion rules R1 making it possible to convert them according to the expectations of the chosen standard, whether it involves Standard 1 or Standard 2, and taking into account the rules of organization and control R2 to organize the exchanges, control them or produce traceability recordings.

The data DAS resulting from the conversion done by OP1 is therefore in accordance with the data model of the standard(s), correctly controlled and grouped together in an exchange lot, but is still described in the RDF formalism of the semantic web. In the case where both Standard 1 and Standard 2 are considered, two conversions are done, making it possible to obtain resulting data for each standard.

A second processing operation OP2 makes it possible to publish these data DAS in the formalism(s) of the chosen standard(s), whether it involves DAPS files in a usual format, for example EXCEL®, XML, in RDF databases or by access via Web services.

The processing operations OP1 and OP2 performed bijective conversions: they always use the same sets of rules R1 and R2 to convert DA into DAS and vice versa, DAS into DA, as well as DAS into DAPS and vice versa, DAPS into DAS.

The data extractions from the application A to produce DA or to introduce data DA into the application is done by specific connectors developed using the program interface of the application A. These interfaces can be executed through the man-machine interface of the application A on a station 20.1, 20.2, . . . , 20.n of FIG. 1, or on the administration unit 40.

The conversion rules R1 equate the attributes of the data model A (MA) with a dictionary providing a shared vocabulary (RDL of FIG. 2). This equivalence can be simple or can result from a combination of attributes. The vocabulary can be defined and maintained by a standardization entity, made available by reference players (either within a project or community) or can be created for the specific needs of the company (private RDL). In order to make the processing operations as homogenous as possible, these conversion rules R1 systematically generate a private RDL, the next equivalency is done between a term of the private RDL and a term of a public RDL by substitution of the terms of the vocabulary, knowing that the grammar of the standard is respected before and after the substitution.

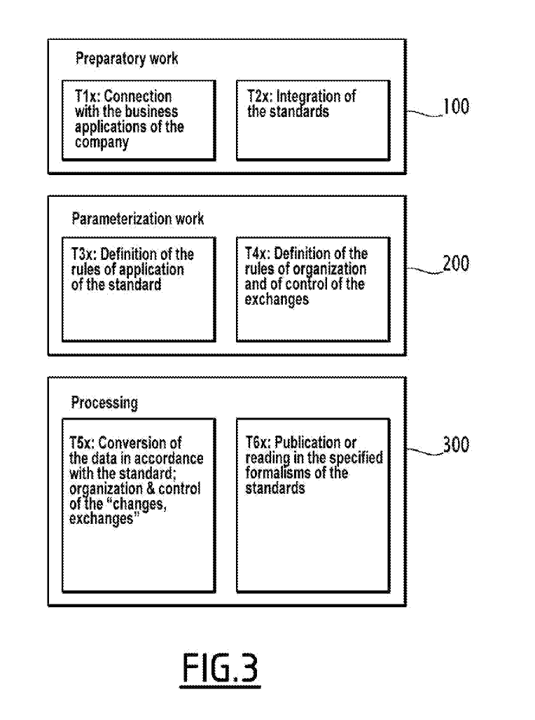

FIG. 3 shows the main steps of the method according to an embodiment of the invention implemented by one of the processing operations on the server 30.

Three processing blocks are shown, i.e., a preparatory work block 100, a configuration work block 200 and a block 300 of actual processing operations of the data, respectively corresponding to the processing operations OP1 and OP2 of FIG. 2.

Preparatory work 100 is necessary, making it possible to obtain, if applicable, the model MA of the application and the associated data DA (T1x) and the models M1, M2 of the standards in the semantic web format (T2x).

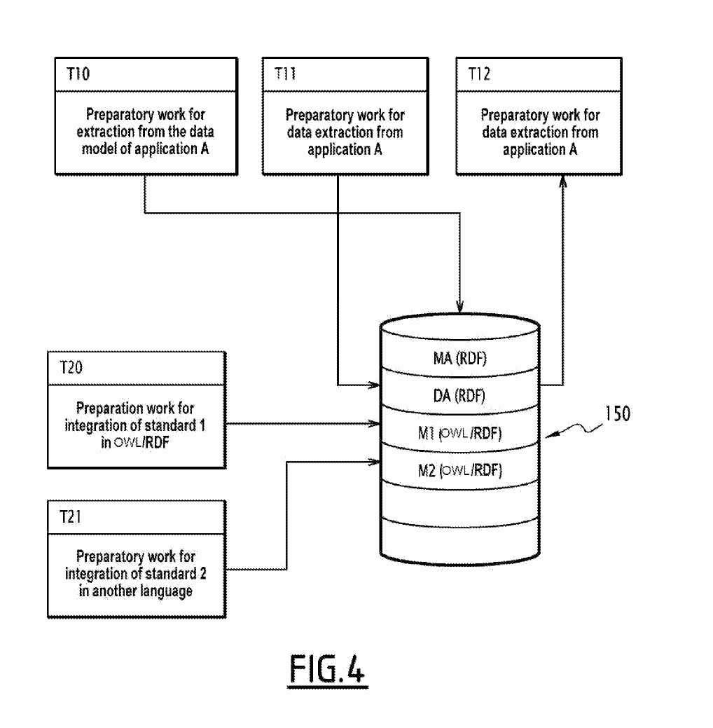

The preparatory processing is illustrated in more detail in FIG. 4. The processing operations T1x (T10, T11, T12, etc.) aim to exchange data of the application A with its formalized equivalent in the semantic web data representation language, i.e., the RDF language. The RDF language offers a means for expressing the data in an elementary manner in order to be able to be converted in the form of instances in the data models of the application with which it is provided to exchange data, using data conversion rules.

Pragmatically, this task consists of accessing the data of the application A via one of the interfaces offered by this application to convert them into RDF triplets (Subject, Predicate, Object). The predicates reference concepts (Classes, properties). In this conversion, a separation is done between the processing T10 of the data model (MA) and the processing T11 of the data (DA). The conversion of the data model of the application into a model MA is only done once as long as the data model of the application A has not changed in the processing operation T10; the changes come from planned evolutions of that application A that generally follow one another over a period of several years.

In order to better explain embodiments of the invention, an example of data (DA) in triplet form is considered. Consider the instance of a valve: VALVE (Tag: #1#, Diameter=50 m), which bears tag #1# and which has a diameter of 50 meters (m). The conversion program T10 would produce, in the following four triplets:
Valve#1# type <VALVE>
Valve#1#<Tag>#1#
Valve#1#<Diameter>50
Valve#1#<Unit> m

For this step T10, depending on the nature of the technology of the application A (relational or semantic database, XML files, Excel® application), connectors are developed (in export or import depending on the needs), using traditional programming languages (C++, Java or others), associated with the program interfaces provided by the publishers of these applications (for example, the publishers of PLM applications making it possible to manage a technical data referential or CAD applications making it possible to perform a computer-assisted design).

The preparatory work processing operations for data extraction consist of extracting (processing operation T11) the data DA from the application A to store it according to the RDF data model in a memory 150 of the computer exchange server 30, or to import data DA in RDF toward the application A (processing application T12).

The processing operations T2x seek to convert the data model of the chosen standard, whether it involves Standard 1 or Standard 2, into the semantic web model representation formalism, i.e., into the OWL modeling language. If the model of the chosen standard is itself expressed in the OWL language, this task is not necessary. This is the case for ISO15926, but also for other standards, for example PLCS (Product Life Cycle Support), standard ISO 303-239 and BIM for Building Information Model, which are expressed in OWL.

In the case where the data model of the processed standard is not in OWL language, a conversion of the data model in its representation formalism (for example UML, XML-Schema, EXPRESS) into the OWL language is done at the processing operation T20, T21. To that end, it is possible to use software bricks on a shelf. The software bricks are, inter alia, UML2OWL, XSD2OWL or Express2OWL for the UML, XML-Schema or EXPRESS representation formalisms, respectively. Thus, the conversion of the data model from Standard 1 into the OWL language is done in step T20, and the conversion of the data model from Standard 2 into the OWL language in step T21.

These steps T20, T21 in principle only apply as long as the formalism of the chosen standard has not changed.

In the following steps, an ontology designates the result of the formulation or conversion of the data model into the OWL language.

Configuration and organization processing operations of the exchanges make up the second part of the process, as shown by block 200 in FIG. 3. The processing operations T3x define the conversion rules R1 making it possible to convert the data into the expression language of the chosen standard(s) and the processing operations T4x make it possible to define the rules of organization and control R2 to organize, control and monitor the exchanges.

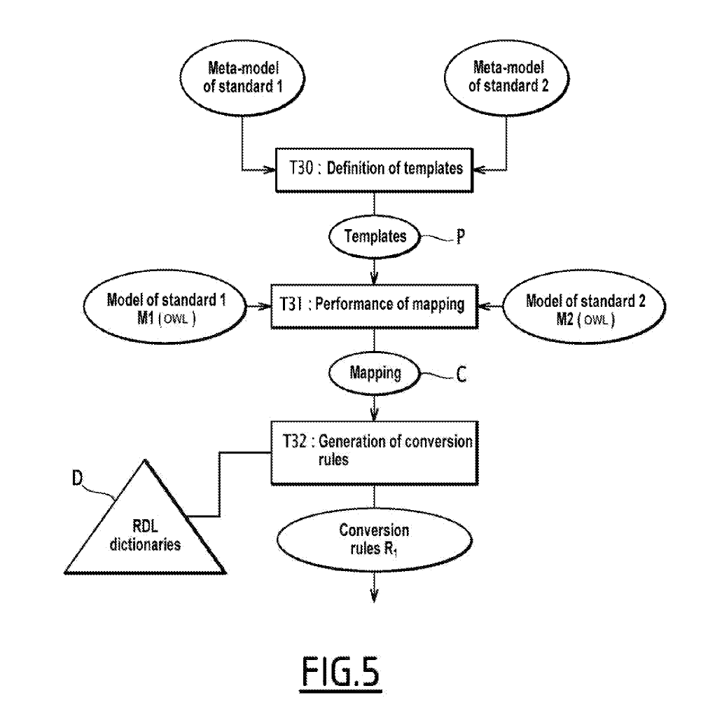

FIG. 5 shows the organization of the processing operations T3x in the input data and results produced.

The processing operations T3x seek to define the conversion rules R1 that will be used to convert the data of the application A formalized in an RDF language resulting from the preparatory processing operations T10 to T12 in accordance with the OWL format(s) of the standard(s) resulting from the preparatory processing operations T2x.

The produced conversion rules R1 are not coded in a program, but are expressed declaratively. A rule is made up of a pair: (condition, actions). The condition is a Boolean expression that applies to the data. If it is met, it triggers the execution of the set of predefined operations such as addition, modification or deletion operations, or combinations thereof. The conversion rules are executed by a rule execution engine commonly termed a reasoner. Reasoners are computer programs that are fairly complex to implement, but many reasoners are commercially available (Pellet®, Racer®, SPINEngine®, etc.). The experiments of the method according to embodiments of the invention were conducted on the SPINEngine® reasoner by the publisher TopQuadrant.

The SPIN (SPARQL Inferencing Notation) language is used to express the rule templates making it possible to create the conversion rules R1. This language makes it possible to encapsulate SPARQL requests, which is a language making it possible to look for, add, modify or delete RDF data. SPIN and SPARQL are two semantic web languages.

The approach, based on declaratory rules, offers the possibility of defining an evolutive and flexible environment to adapt to various needs without the help of computer developers to perform corrections or extensions. Furthermore, it offers users the possibility of defining, extending and modifying rules (or their templates) easily, following new needs and/or following the impact of the modification of one of the ontologies for which one seeks to define conversion rules R1. This definition of conversion rules is the result of a three-step process, as illustrated in FIG. 5, the steps of which are respectively:
Processing T30: Definition of rule templates
Processing T31: Definition of correspondence rules between the ontologies based on these rule templates
Processing T32: Generation of conversion rules R1.

The evolution and flexibility of the algorithm are reflected by the use of templates. A rules template is a generic rule that bears a semantic while implementing simple or complex operations. A template is characterized in that it defines input parameters and implements a certain conversion and/or encoding logic to be done based on those parameters. A rule is nothing more than a template instance with values specific to the parameters thereof, as explained in the processing operation T31.

The number of rule templates and their complexities, to be defined during the processing operation T30, depend on major differences that may exist between the semantic of the models M1, M2 (for applications/ontologies), defined from the models of the standards, for which the correspondence rules are created. The generic rules templates make it possible to conceal the diversity of the data models of the chosen standards (Standard 1 or Standard 2 in the example) in support for the exchanges or the interoperability functions.

Here are several examples of rule template definitions:
Name: ClassificationRuleTemplate
   Description: Rule template that makes it possible to create an instance of the class of Standard 1 in the model of Standard 2.
   Parameter 1: A Class in Standard 1
   Parameter 2: A Class in Standard 2
   Parameter 3: A variable for traveling over all of the instances of standard A
Name: PropertyUnitConversionRuleTemplate
   Description: Rule template that makes it possible to convert a value of property P of Standard 1 into the Unit System of Standard 2
   Parameter 1: The property of Standard 1
   Parameter 2: The property of Standard 2
   Parameter 3: The value unit of the property of Standard 1
   Parameter 4: The value unit of the property of Standard 2
   Parameter 5: the data conversion function

At the end of step T30, a set of rule templates P is stored.

The processing operation T31 for defining mappings C between the two data models consists of building semantic links between concepts (classes and/or properties and/or instances) of the models. For each mapping between concepts, the user associates two rule templates in order to be able to convert data from Standard 1 into Standard 2 and vice versa. In that case, the mapping C is reversible.

In one alternative, the user can provide only one rule template, for example from Standard 1 to Standard 2. In that case, the mapping C is mono-directional, and not reversible.

Step T31 is a key step of the process because it requires in-depth knowledge of the models (Standard 1 and Standard 2) to establish the mappings, which are semantic links, as in the choice of rule templates.

A data model is defined to express these mappings C with their associated rule templates P. The instances of data models making up the mapping that will be at the input of the rule generator T32 will be described in the following step.

Several examples of mappings are provided below:
Mapping 1:
   The mapping of the VALVE class of Standard 1 with the VALVE class of Standard 2.
   Template (1→2): ClassificationRuleTemplate
   Template (2→1): ClassificationRuleTemplate
Mapping 2:
   The mapping of the DIAMETER property of Standard 1, which is in meters, with the RADIUS property of Standard 2, which is in centimeters.
   Template (1→2): PropertyUnitConversionRuleTemplate
   Template (2→1): PropertyUnitConversionRuleTemplate

The last step T32 of the process consists of producing the conversion rules R1 that will be provided to the reasoner (as described below in reference to the processing operation T51) to produce the data. The rule generator of step T32 uses, as input, the results of the processing operation T31:
The list of rule templates with their parameters.
The mapping of the two standards.
The associations with an RDL dictionary.

In the processing operation T32, the different classes of objects and attributes are described by a local RDL dictionary generated automatically, denoted D in FIG. 5, both connected to the vocabulary of the standard(s) and resulting from the interface applications. This local dictionary is called Internal RDL.

In the processing operation T32, conversion rules R1 are defined, making it possible to set out equivalencies between this internal RDL and the available dictionaries, whether they are published within a standardization body, a community, or a project. If no match is found in these dictionaries, the internal RDL can then serve as a basis for a private or project RDL, or even a community RDL, that can then be integrated into a standard.

In order to optimize the processing operations in the reasoners, two sets of rules are produced and stored separately: one set of rules for each data conversion direction ([Standard 1→Standard 2] and [Standard 2→Standard 1]). Each set of rules is executed according to the expressed needs: 1→2 or 2→1.

For the following example, the generator of step T32 builds the following conversion rules (Standard 1→2 Standard 2→1)
Rule R11—to convert all of the instances of VANNE into VALVE
   Template: ClassificationRuleTemplate
   Parameter 1: VANNE
   Parameter 2: VALVE
   Parameter 3: ?this
Rule R12—to convert all of the diameter values of the VANNE instances into VALVE radius
   Template: PropertyUnitConversionRuleTemplate
   Parameter 1: DIAMETER
   Parameter 2: RADIUS
   Parameter 3: meter
   Parameter 4: centimeter
   Parameter 5: diameter2radius

The purpose of the processing operations T4x is to define the rules of organization and control R2 making it possible to organize, control or monitor the exchanges.

To that end, a processing module is developed to add rules of organization and control R2 complementary to the conversion rules R1 produced by the processing operation T3x, and the purposes of which are to build metadata in the form of relationships on the data of the applications, whether they are in their original form (i.e., according to the data model of the application, for example MA for the application A) or expressed in the language of the chosen standard(s) (M1 for Standard 1 and M2 for Standard 2). These rules of organization and control of the exchanges R2 make it possible to meet the contractual and confidentiality requirements of the information to be shared and control the information to be integrated.

The processing operations T4x are broken down into steps.
T41: Establishment of relationships and their hierarchical organizations/classifications in packages (directories) for their publications.
T42: Publication of data that will seek to execute the packages and optionally send it to internal or external partners.

The relationships are complementary links between a datum and:
A selection criterion or a request (making it possible to filter the date of the exchange)
A version (making it possible to verify the updates of those data).
An exchange lot (making it possible to group together different types of data to be exported simultaneously).
A control rule (making it possible to determine whether a received datum respects certain coherence rules) or if the authorization to modify the datum is available.
A traceability registration (version).
A set of packages where the relationships are classified.
The data source in which the relationship will be executed. Note that the data source can be either:
   The database of the application
   A data façade of a standard
   The aggregation of several data sources
This last type of data source will allow the federation/integration of all data sources. The relationship request will be sent in parallel in the data source.

Step T41 for establishing the relationship is followed by a publication step T42.

The exchange lot can also have additional relationships with:
A format (not necessarily unique)
A recipient (not necessarily unique)
The address of information storage zones accessible by the recipient (on the server 30 or the server 30m), which can be the HTTP address of the façade, an FTP server, a shared drive.

At the end of the publication T42, an execution summary is produced, formally recognizing the exchange and which can be associated with a dated and signed log, which may be authoritative in contractual exchanges.

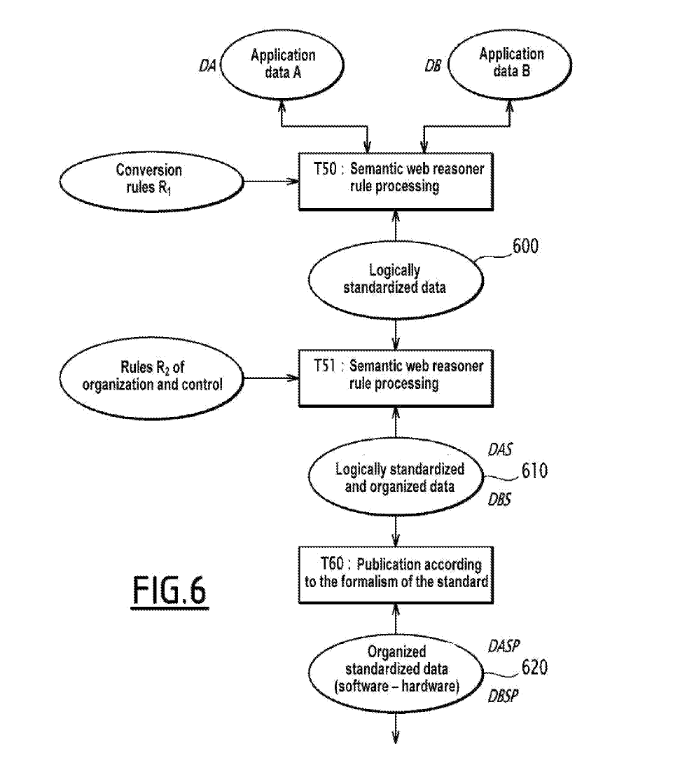

FIG. 6 is a more detailed illustration of the conversion processing operations T5x and T6x of FIG. 3. The processing operation T50 first produces data 600 presented according to the logic of Standard 1, Standard 2 following the execution of the rules resulting from T3x, based on the stored sets of rules R1 and R2. The processed application data, data DA for the application A and data DB for the application B, are provided at the input of the processing operation T50.

The processing operation T51 organizes and controls the data to be exchanged according to the execution of the rules R2 resulting from T4x. At the output of the processing operation T51, standardized and organized data 610, denoted DAS for the application A and DBS for the application B, are obtained.

The processing operation T60 converts these formalized RDF data 610 into data recommended by the chosen standard, i.e., Standard 1 or Standard 2.

The processing operations T50 and T51 are in reality identical, applied by a rules execution engine or Reasoner.

For example, the reasoner produces the following VALVE instance:
Valve#1# type <VALVE>
Valve#1#<ID> #1#
Valve#1#<radius> 2500
Valve#1#<Unit> cm

The purpose of the processing operation T60 is to convert the data 610 that are logically expressed and organized into data 620 respecting a formalism recommended by the standard(s) chosen to support the exchange. This formalism can be EXCEL®, XML or an RDF/OWL format. In the latter case, the processing operation T60 is pointless, the data 610 DAS, DBS already being formalized in RDF. Data 620, denoted DASP for the application A and DBSP for the application B, are obtained.

For the other formats, the processing operation T60 is comparable to a connector as defined in the processing operation T12. It is specific to the chosen standard.

The processing operations T12, T50 T51 and T60 can operate in both directions (export and import with respect to the application A and a partner).

1-13. (canceled)

14. A method of exchanging data descriptive of technical installations between at least two applications, a said application being able to provide and/or to consume data according to an associated application data model, the method allowing interoperability between applications by virtue of an exchange of the data expressed and formalized through at least one chosen standard having an associated data model and associated exchange formats, implemented by a programmable device, the method comprising, for at least one considered application:
integrating the application data model in a same semantic web data representation language, termed a common representation language;
for each chosen standard, integrating the data model of the standard into a semantic Web modeling language;
obtaining of first conversion rules between the application data model in the common representation language and the data model(s) of the chosen standards in the semantic web modeling language;
obtaining second rules of organization and control of the data to be exchanged;
converting of the application data using the first and second obtained rules into data according to the exchange format(s) associated with the chosen standards; and
exchanging data obtained in the conversion step according to the exchange format(s) associated with the chosen standards.

15. The method as recited in claim 14 wherein the obtaining first conversion rules includes the definition of unified conversion rules between application data and the chosen standard(s), based on generic rules templates.

16. The method as recited in claim 15 wherein the first conversion rules obtained are bijective rules, allowing a conversion of the application data to the chosen standard(s), and a conversion of data according to the chosen standard(s) to data according to the application model.

17. The method as recited in claim 15 wherein the first conversion rules are expressed declaratively and stored in one or several files.

18. The method as recited in claim 14 wherein the obtaining of first conversion rules includes the creation or update of an internal reference dictionary, in connection with the chosen standard(s).

19. The method as recited in claim 14 wherein the obtaining of second rules includes the definition of rules of organization and control of the exchanges making it possible to meet contractual requirements, satisfy confidentiality requirements of the information to be shared, or control the information to be integrated.

20. The method as recited in claim 19 wherein said second rules define exchange lots, making it possible to filter, among the data of the application, a subset of data to be exchanged.

21. The method as recited in claim 14 wherein the integration of the application data model in a semantic web data representation language, includes two sub-steps, a first sub-step of converting the application model into the semantic web data representation language and a second sub-step of actual conversion of the data of the application by instantiation of the converted application model resulting from the first sub-step.

22. The method as recited in claim 14 wherein said shared presentation language of the semantic web data is the RDF language.

23. The method as recited in claim 14 wherein said semantic Web modeling language is the OWL language.

24. The method as recited in claim 14 wherein one of the chosen standards is standard ISO15926.

25. A programmable device for exchanging data descriptive of technical installations between at least two applications, a said application being able to provide and/or to consume data according to an associated application data model, allowing interoperability between applications by virtue of an exchange of the data expressed and formalized through at least one chosen standard having an associated data model and associated exchange formats, comprising, for at least one considered application, the programmable device comprising:
a first integrator configured for integrating the application data model in a same semantic web data representation language, termed a common representation language;
a second integrator configured, for each chosen standard, for integrating the data model of the standard into a semantic Web modeling language;
a first obtainer configured for obtaining first conversion rules between the application data model in the common representation language and the data model(s) of the chosen standards in the semantic web modeling language;
a second obtainer configured for obtaining second rules of organization and control of the data to be exchanged;
a converter configured for converting data of the application by using the first and second obtained rules into data according to the exchange format(s) associated with the chosen standards; and
an exchanger configured for exchanging data obtained in the conversion step according to the exchange format(s) associated with the chosen standards.

26. A computer program product, disposed on a non-transitory computer readable media, including instructions for carrying out the method for exchanging data descriptive of technical installations between at least two applications as recited in claim 14 during the execution of the program by a processor of a programmable device.
